(19) United States
(12) Patent Application Publication
(10) Pub. No.: US 2026/0161447 A1
(43) Pub. Date: Jun. 11, 2026

(54) OPERATION SUPPORT DEVICE

(71) Applicant: Hitachi, Ltd., Tokyo (JP)

(72) Inventors: Mineyoshi MASUDA, Tokyo (JP); Mitsuhiro NAGATA, Tokyo (JP)

(21) Appl. No.: 19/315,967

(22) Filed: Sep. 2, 2025

(30) Foreign Application Priority Data
Dec. 5, 2024 (JP) 2024-212898

(51) Int. Cl. G06F 9/48; G06F 40/40

(52) U.S. Cl. CPC G06F 9/4881; G06F 40/40

(57) ABSTRACT

A storage unit stores a procedure manual table describing a procedure of the response operation according to the event for each of the operations and an operation instruction table in which an agent operation instruction which is support information for supporting the operation of an agent is indicated for each response operation. When the operation procedure in the procedure manual table is referred to in the task based on the instruction sentence, the CPU provides the agent with an agent operation instruction corresponding to the target operation that is the response operation performed according to the operation procedure, and causes the agent to execute the task on the basis of the agent operation instruction.

### CROSS-REFERENCE TO RELATED APPLICATION

The present application claims priority from Japanese application JP2024-212898, filed on Dec. 5, 2024, the content of which is hereby incorporated by reference into this application.

### BACKGROUND OF THE INVENTION

### 1. Field of the Invention

The present disclosure relates to an operation support device.

### 2. Description of the Related Art

With the spread of information technology (IT) services, the importance of troubleshooting of an IT system that provides IT services increases. In the troubleshooting of an IT system, when an event such as an abnormality related to the IT system occurs, an operation manager in charge of operation and maintenance of the IT system needs to perform an appropriate task according to the event. Therefore, in a case where an event occurs, a person in charge of operation generally checks a procedure manual created in advance and performs a task according to a procedure described in the procedure manual.

However, there are a wide variety of events related to an IT system, and the contents and occurrence situations thereof are complicated. Therefore, it is not easy for the operation manager to check the procedure manual, specify an appropriate procedure, and perform the operation according to the procedure.

In addition, in recent years, a generative artificial intelligence (AI) agent technology that autonomously executes a task using a generative AI model has attracted attention. The generative AI model is suitable for generating content according to an input instruction sentence, but is not suitable for executing complex processing such as processing for making a decision and processing including a plurality of steps. For this reason, in the generative AI agent technology, a program called an AI agent compensates for processing that the generative AI model is not good at, and dynamically makes a decision using the generative AI model while interacting with the user. For example, U.S. Pat. No. 10,740,566 discloses a technique capable of classifying the intention of a sentence input from a user.

By applying such a generative AI agent technology to troubleshooting of an IT system, the AI agent can dynamically generate information regarding an appropriate operation procedure with reference to the procedure manual. As a result, the operation of the operation manager can be made efficient, and the operation according to the event can be sped up.

### SUMMARY OF THE INVENTION

There are usually a plurality of AI agents, and each of the AI agents has a plurality of tools constructed with a Python function or the like. In the generative AI agent technology, these AI agents cooperate to supplement processing that the generative AI model is not good at. However, it is not easy to cause an appropriate AI agent to execute an appropriate tool according to the procedure manual.

An object of the present disclosure is to provide an operation support device capable of appropriately executing an operation according to an event.

A operation support device according to one aspect of the present disclosure is an operation support device that supports an operation corresponding to an event by using an AI agent that executes a task based on an instruction sentence related to the operation, the operation support device including: a storage unit that stores procedure manual information describing a procedure of the operation for each of the operations and auxiliary information indicating support information for supporting an operation of the AI agent for each of the operations; and a control unit that, in a case where the procedure in the procedure manual information is referred to in the task, provides support information corresponding to a target operation that is the operation performed according to the procedure to the AI agent, and causes the AI agent to execute the task on the basis of the support information.

According to the present invention, it is possible to appropriately and quickly perform an operation according to an event.

### BRIEF DESCRIPTION OF THE DRAWINGS

FIG. 1 is a diagram illustrating a configuration of a management computer according to an embodiment of the present disclosure;

FIG. 2 is a diagram illustrating an example of a procedure manual table;

FIG. 3 is a diagram illustrating an example of an operation instruction index table;

FIG. 4 is a diagram illustrating an example of a group-based operation instruction index table;

FIG. 5 is a diagram illustrating an example of an operation instruction table;

FIG. 6 is a diagram illustrating an example of an agent table;

FIG. 7 is a diagram for describing an example of an LLM service table;

FIG. 8 is a diagram for explaining an example of task execution processing;

FIG. 9 is a flowchart for explaining a more detailed example of task execution processing;

FIG. 10 is a flowchart for explaining another more detailed example of task execution processing;

FIG. 11 is a flowchart for explaining an example of creation processing; and

FIG. 12 is a flowchart for explaining another example of creation processing.

### DESCRIPTION OF THE PREFERRED EMBODIMENTS

Hereinafter, embodiments of the present disclosure will be described with reference to the drawings. Note that, in the following description, there is a case where processing is described with a “program” as a subject, but the subject of the processing may be the processor (alternatively, a device or system having the processor) since the program is executed by the processor (for example, a central processing unit (CPU)) to perform defined processing appropriately using the storage unit (for example, memory) and/or the interface device (for example, a communication port). Furthermore, the processor may include a hardware circuit that performs a part or all of the processing. The program may be installed in a device such as a computer from a program source. The program source may be, for example, a program distribution server or a computer-readable storage medium. In the following description, two or more programs may be implemented as one program, or one program may be implemented as two or more programs.

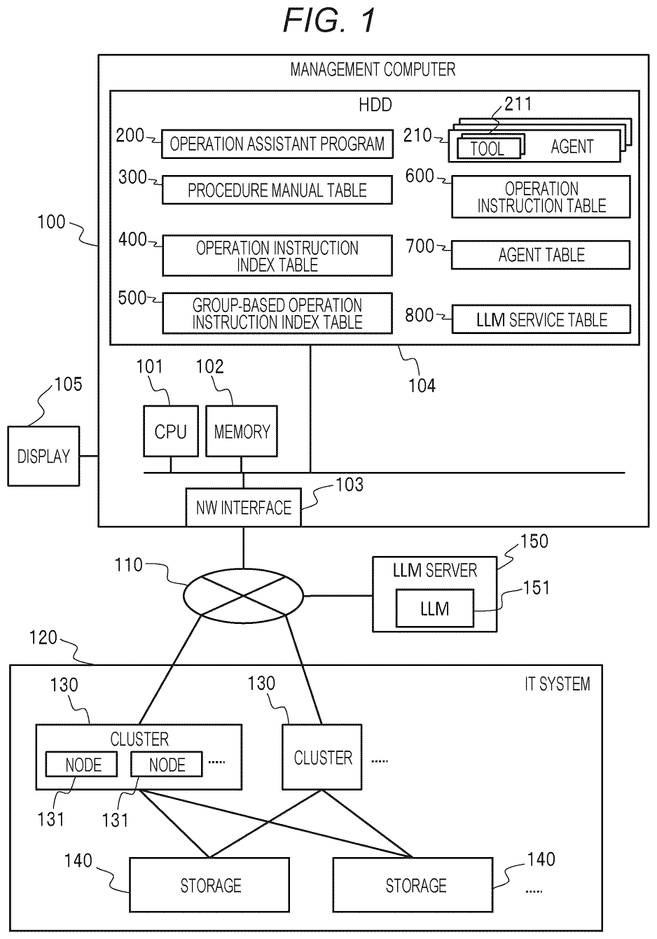

FIG. 1 is a diagram illustrating a configuration of a management computer according to an embodiment of the present disclosure. A management computer 100 illustrated in FIG. 1 is communicably connected to an IT system 120 and an LLM server 150 via a local area network (LAN) 110.

The IT system 120 is a system to be managed by the management computer 100, and includes a plurality of clusters 130 and a plurality of storages 140. The cluster 130 includes a plurality of nodes 131, which are computers that perform various processes, and operates as one system by linking the plurality of nodes 131. The storage 140 stores various data generated or used in the processing of the cluster 130.

The LLM server 150 includes a large language model (LLM) 151 and is a generative AI server that performs various processes using the LLM 151. In the present embodiment, the LLM server 150 is an on-premises server, but may be arranged on a public cloud (not illustrated). The LLM 151 is a generative AI model that generates and outputs content corresponding to an input prompt. In the present embodiment, the content is text (character information).

The management computer 100 is a device for supporting operation management of the IT system 120, and more specifically, is an operation support device for supporting a response operation which is an operation corresponding to an event by a user who is an operator of the IT system 120 when an event such as an abnormality related to the IT system 120 occurs.

The management computer 100 includes a CPU 101, a memory 102, a network (NW) interface 103, and a storage unit 104. In addition, the management computer 100 is connected to a display 105 that displays various types of information.

The CPU 101 is a processor that functions as a control unit that controls the management computer 100, reads a program stored in the storage unit 104, executes the read program using the memory 102 as a work area, and performs various processes.

The NW interface 103 is a communication unit that is communicably connected to the IT system 120 and the LLM server 150 which are external devices via the LAN 110 and transmits and receives data to and from the IT system 120 and the LLM server 150.

The storage unit 104 is, for example, a hard disk drive (HDD) or the like, and stores a program that defines the operation of the CPU 101 and various data generated or used in the program. In the present embodiment, the storage unit 104 stores an operation support program 200 and an agent 210 as programs. In addition, the storage unit 104 stores, as data, a procedure manual table 300, an operation instruction index table 400, a group-based operation instruction index table 500, an operation instruction table 600, an agent table 700, and an LLM service table 800.

The operation support program 200 is a program for supporting operation management of the IT system 120 using the agent 210.

The agent 210 is an AI agent that includes a plurality of tools 211 that perform specific processing, and autonomously performs a task, using the tool 211 and the LLM 151 in the LLM server 150, based on an instruction from a user (here, the operation manager of the IT system 120) who uses the management computer 100 to the management computer 100. Although there are a plurality of agents 210 in the present embodiment, one agent may be provided. Note that, in the present embodiment, the instruction to the management computer 100 is performed by an instruction sentence described in a natural language such as an instruction to a human.

The LLM 151 is in charge of interpretation and generation of sentences and the like, and the tool 211 is in charge of processing that the LLM 151 is not good at. Examples of the processing performed by the tool 211 include processing requiring numerical calculation and processing of searching for information. Each of the plurality of agents 210 may have different tools 211 and may execute different processing. For example, the agent 210 may include an agent that handles events, an agent that handles documents, and the like. Furthermore, in a case where there are a plurality of agents 210, a host agent that manages other agents is included in the plurality of agents 210, and the host agent sequentially operates the other agents according to an instruction from the user and performs a task according to the instruction.

The procedure manual table 300 is procedure manual information indicating a procedure manual describing a procedure of a response operation which is an operation according to an event related to the IT system 120. The procedure manual is information written in natural language for humans. In the present embodiment, the procedure manual is converted into a file for each response operation and stored in the storage unit 104 or an external storage device (not illustrated).

The operation instruction index table 400 is index information for searching for an agent operation instruction for instructing the operation of the agent 210, and indicates the agent operation instruction corresponding to the response operation for each response operation. The agent operation instruction is an example of support information for supporting the operation of the agent 210. Note that the agent 210 does not necessarily operate according to the agent operation instruction, and determines the actual operation with reference to the agent operation instruction.

The group-based operation instruction index table 500 is another example of index information, and indicates an agent operation instruction for the agent 210 according to the operation group for each operation group including a plurality of response operations similar to each other.

The operation instruction table 600 is auxiliary information indicating an agent operation instruction according to the response operation for each response operation. The agent table 700 is agent information related to the agent 210. The LLM service table 800 is generative AI information related to the LLM 151.

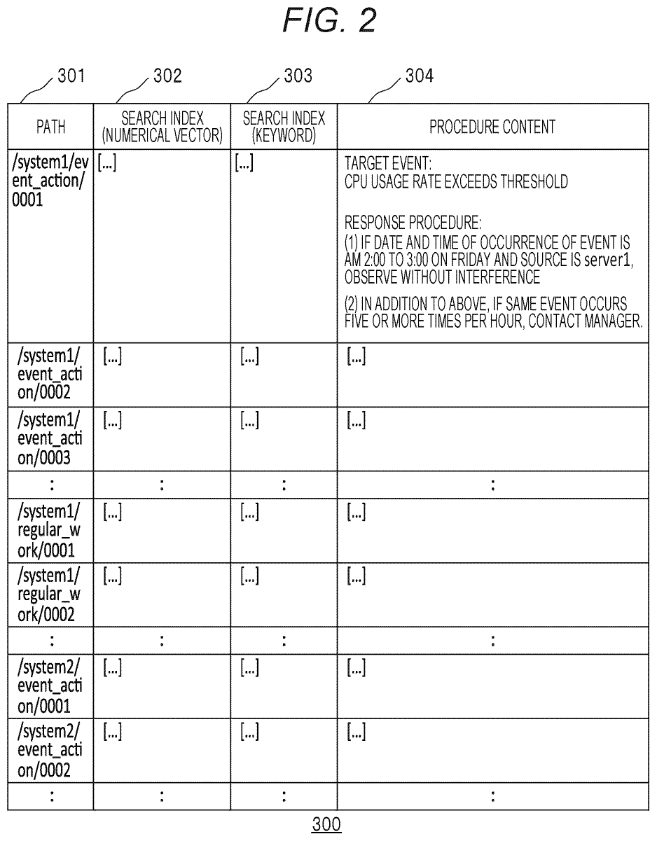

FIG. 2 is a diagram illustrating an example of the procedure manual table 300. The procedure manual table 300 illustrated in FIG. 2 includes fields 301 to 304 for each record.

The field 301 stores path information indicating a location where a file describing the response operation included in the procedure manual is stored as identification information for specifying the response operation described in the procedure manual.

The fields 302 and 303 store a search index for searching for the response operation. Specifically, the field 302 stores, as the search index, a numerical vector reflecting the meaning of the content of the response operation. The numerical vector is generated from the content of the response operation using, for example, embedding processing. In this case, the more similar the contents of the two response operations are, the smaller the distance between the numerical vectors becomes. In addition, the field 303 stores a keyword included in the content of the response operation as a search index.

The field 304 stores operation details that are content of the response operation. The operation details include a target event that is an event requiring a response operation and a procedure of the response operation.

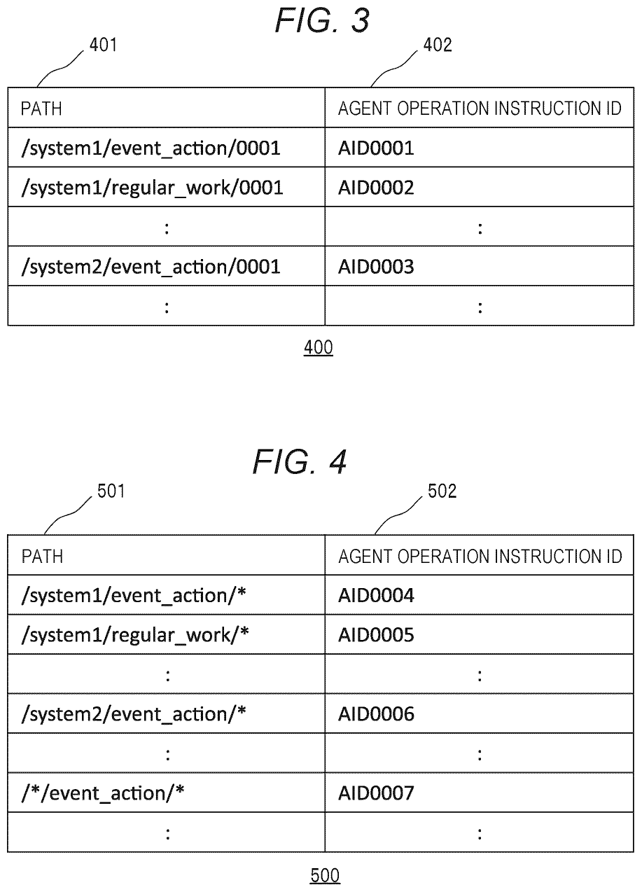

FIG. 3 is a diagram illustrating an example of the operation instruction index table 400. The operation instruction index table 400 illustrated in FIG. 3 has fields 401 and 402 for each record.

The field 401 stores path information that is identification information of the response operation. The field 402 stores an agent operation instruction ID for identifying an agent operation instruction corresponding to the response operation.

FIG. 4 is a diagram illustrating an example of the group-based operation instruction index table 500. The group-based operation instruction index table 500 illustrated in FIG. 4 has fields 501 and 502 for each record.

The field 501 stores, as identification information for identifying an operation group including a plurality of response operations similar to each other, group path information indicating a location where a file describing response operations included in the operation group is stored. In the present embodiment, the group path information is represented by a regular expression including a storage location of a file describing response operation included in the operation group. The field 502 stores an agent operation instruction ID for identifying an agent operation instruction corresponding to the operation group.

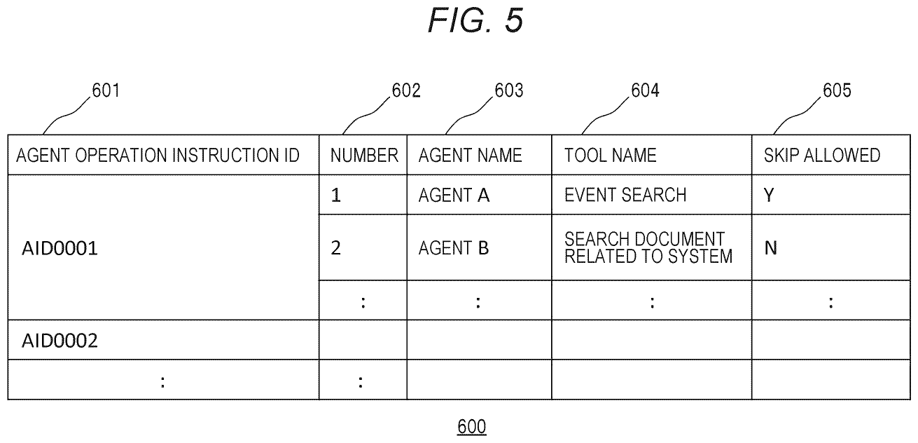

FIG. 5 is a diagram illustrating an example of operation instruction table 600. The operation instruction table 600 illustrated in FIG. 5 includes fields 601 to 605 for each record.

The field 601 stores an agent operation instruction ID for identifying an agent operation instruction. The fields 602 to 605 store the instruction content of the agent operation instruction identified by the agent operation instruction ID of the same record. Specifically, the field 602 stores a number indicating the execution order of the agent 210. The field 603 stores an agent name which is the name of the agent as identification information for specifying the agent 210 instructed to execute by each number. The field 604 stores a tool name, which is a name of a tool, as identification information for specifying the tool 211 instructed to be used in the agent instructed to execute. The field 605 stores skip permission information indicating whether execution of the tool instructed to be used can be skipped. The skip permission information indicates “permission” when the skip is permitted, and indicates “prohibition” when the skip is not permitted.

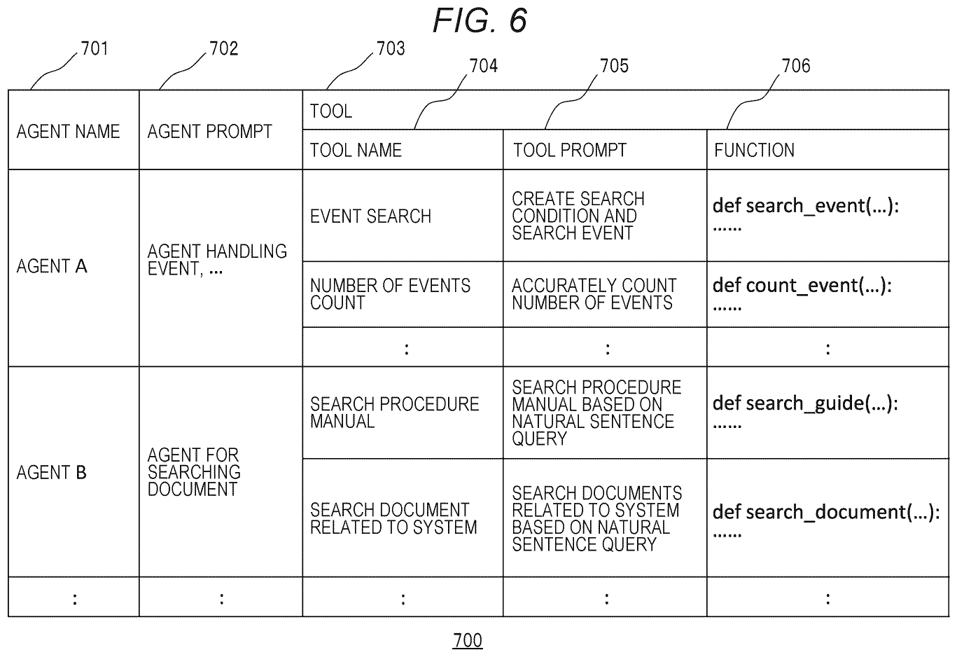

FIG. 6 is a diagram illustrating an example of the agent table 700. The agent table 700 illustrated in FIG. 6 includes fields 701 to 703 for each record.

The field 701 stores an agent name of the agent 210. The field 702 stores an agent prompt which is an explanatory sentence describing contents of the agent 210. The agent prompt is information for causing the LLM 151 to understand the contents of the agent 210. The field 703 stores tool information related to the tool 211 included in the agent 210.

The field 703 specifically includes the fields 704 to 706. The field 704 stores a tool name of the tool 211. The field 705 stores a tool prompt which is an explanatory sentence describing the contents of the tool 211. The tool prompt is information for causing the LLM 151 to understand the contents of the tool 211. The field 706 stores a function that is an entity of the tool.

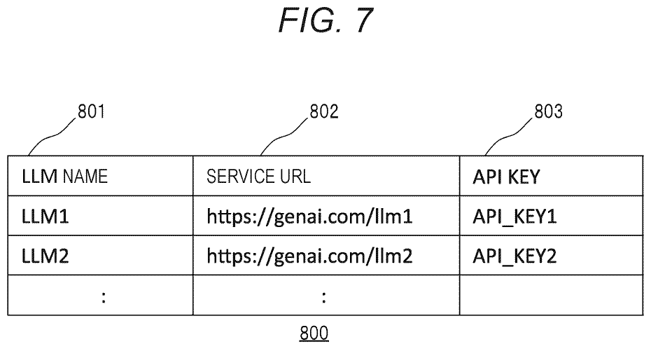

FIG. 7 is a diagram for describing an example of the LLM service table 800. The LLM service table 800 illustrated in FIG. 7 includes fields 801 to 803 for each record.

The field 801 stores an LLM name which is a name of the LLM 151 as identification information for identifying the LLM 151. The field 802 stores a service uniform resource locator (URL) indicating the location of the LLM 151 on the network. The field 803 stores an application programming interface (API) key for using the LLM.

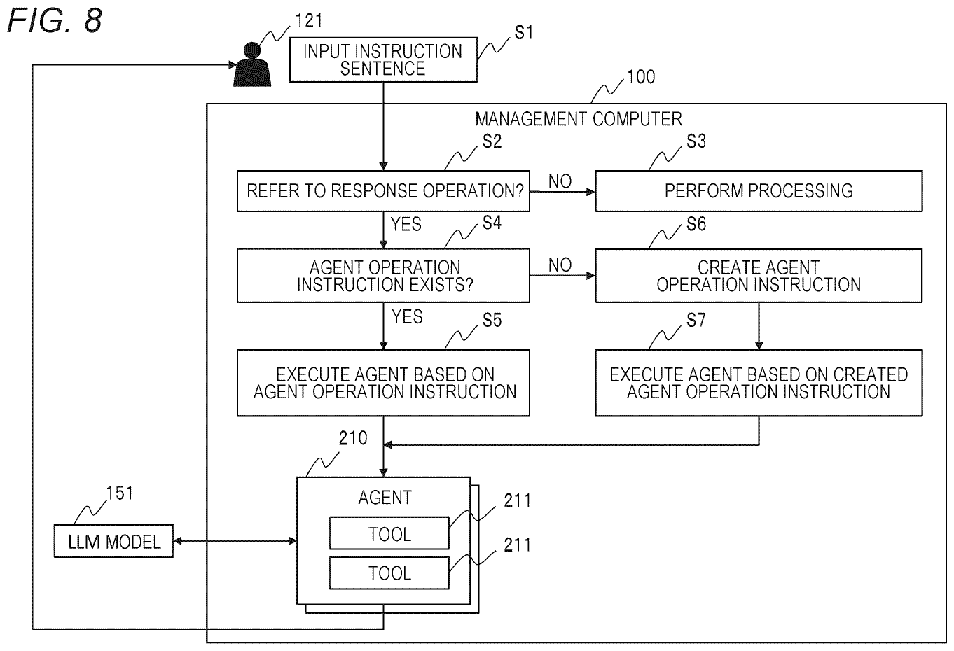

FIG. 8 is a diagram for describing an example of task execution processing by the management computer 100. The task execution processing is processing in which the AI agent 201 executes a task based on the instruction sentence from the user. At that time, when the operation details in the procedure manual table 300 are referred to in the task processing, the operation support program 200 provides the AI agent 201 with an agent operation instruction corresponding to the target operation that is the response operation performed according to the operation details, thereby causing the AI agent 201 to execute the task on the basis of the agent operation instruction.

Specifically, the operation manager 121 of the IT system 120, who is a user who uses the management computer 100, first inputs an instruction sentence to the management computer 100 (step S1).

Subsequently, the operation support program 200 of the management computer 100 determines whether the operation details in the procedure manual table 300 are referred to in the task based on the instruction sentence (step S2). Examples of the process of referring to the operation details include a process of searching the procedure manual table 300 for the operation details.

When not referring to the operation details (step S2: No), the operation support program 200 causes the agent 210 to execute a task (step S3) and ends the processing.

On the other hand, when referring to the operation details (step S2: Yes), the operation support program 200 determines whether there is an agent operation instruction corresponding to the reference operation which is the response operation referred to in the task (step S4).

When the agent operation instruction exists (step S4: Yes), the operation support program 200 operates the agent 210 on the basis of the instruction sentence, the reference operation, and the agent operation instruction (step S5).

When there is no agent operation instruction (step S4: No), the operation support program 200 creates an agent operation instruction corresponding to the reference operation on the basis of a similar operation instruction that is an agent operation instruction corresponding to a similar operation that is a response operation similar to the reference operation (step S6). Then, the operation support program 200 operates the agent 210 on the basis of the created agent operation instruction, instruction sentence, and reference operation (step S7).

Note that the agent 210 executes processing according to the task using the tool 211 and the LLM 151 on the basis of the task, the reference operation, and the agent operation instruction, and outputs the execution result to the operation manager 121 using, for example, the display 105.

Note that the task execution processing described above is merely an example, and the task execution processing is not limited thereto. For example, when there is no agent operation instruction (step S4: No), the operation support program 200 may operate the agent 210 on the basis of the instruction sentence and the reference operation without creating a new agent operation instruction.

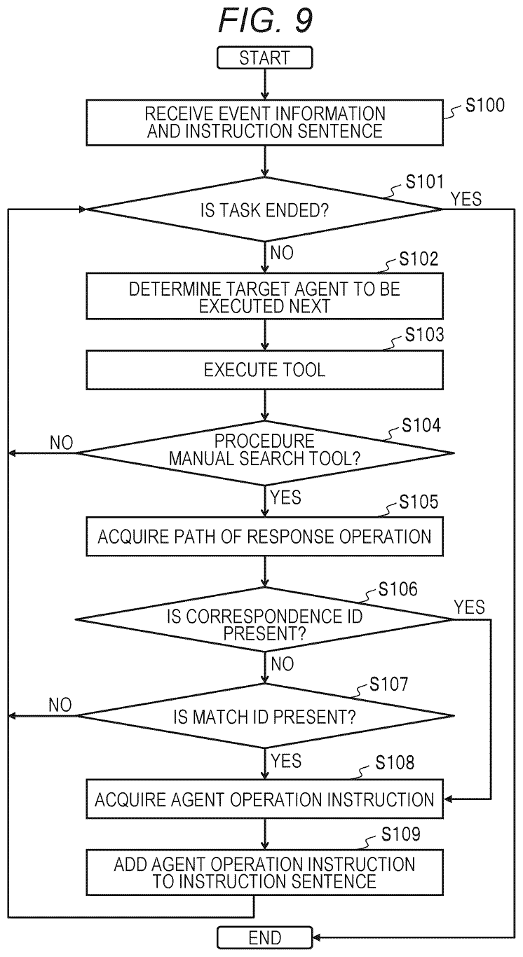

FIG. 9 is a flowchart for describing a more detailed example of the task execution processing. Here, an example in which creation of a new agent operation instruction is not performed in a case where there is no agent operation instruction will be described.

First, the operation support program 200 of the management computer 100 receives the event information indicating the event related to the IT system 120 and the instruction sentence related to the event from the operation manager 121 (step S100). The instruction sentence is, for example, a natural sentence such as “Read the procedure manual corresponding to the selected events, determine the severity of the events, and contact the superior operation manager if it is critical”.

The operation support program 200 determines whether the task based on the received instruction sentence has ended (step S101). When the task processing is ended (step S101: Yes), the operation support program 200 ends the operation.

When the task is not finished (step S101: No), the host agent that manages other agents among the agents 210 determines an agent that executes next processing in the task as the target agent based on the instruction sentence and the event information (step S102).

The target agent determines a tool to be used from among the tools 211 possessed by the target agent as a target tool on the basis of the task and the event information, executes the target tool, and performs processing related to the task (step S103).

The operation support program 200 determines whether the target tool is a procedure manual search tool that searches for a response operation in the procedure manual (step S104). When the target tool is not the procedure manual search tool (step S104: No), the operation support program 200 returns to the processing of step S101.

When the target tool is the procedure manual search tool (step S104: Yes), the operation support program 200 acquires path information of the response operation searched by the procedure manual search tool (step S105). For example, in a case where the procedure manual search tool is a tool that searches for a response operation using a retrieval-augmented generation (RAG) that searches for a document using a generative AI model (for example, LLM 151), when the response operation is searched, path information that is a search source from which the response operation has been searched is acquired. Therefore, the operation support program 200 can acquire the path information from the searched tool.

The operation support program 200 determines whether or not there is a correspondence ID, which is an agent operation instruction ID corresponding to the acquired path information, in the operation instruction index table 400 (step S106).

If there is no correspondence ID (step S106: No), the operation support program 200 determines whether there is a match ID, which is an agent operation instruction ID corresponding to the group path information matching the acquired path information, in the group-based operation instruction index table 500 (step S107). Specifically, the group path information matching the path information is group path information described in a regular expression including the path information.

When there is no match ID (step S107: No), the operation support program 200 returns to the processing of step S101.

If there is a correspondence ID (step S106: Yes) or if there is a match ID (step S107: Yes), the operation support program 200 acquires an agent operation instruction corresponding to the correspondence ID or the match ID from the operation instruction table 600 (step S108). The operation support program 200 adds the acquired agent operation instruction to the instruction sentence (step S109), and returns to the processing of step S101. As a result, the agent 210 can be caused to execute continuation of the subsequent task on the basis of the instruction sentence including the agent operation instruction.

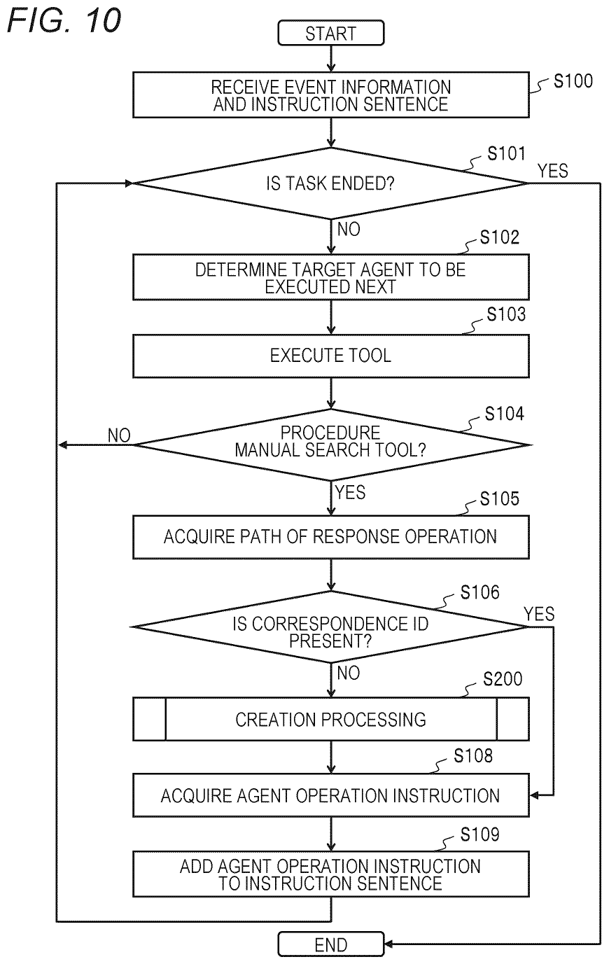

FIG. 10 is a flowchart for describing another more detailed example of the task execution processing. Here, an example in which a new agent operation instruction is created in a case where there is no agent operation instruction will be described.

The task execution processing of FIG. 10 is different from the task execution processing described with reference to FIG. 9 in that, in the processing of step S106, when there is no correspondence ID (step S106: No), the operation support program 200 executes creation processing (step S200) of creating a new agent operation instruction according to the response operation instead of the processing of step S107. When the process of step S200 ends, the process of step S108 is executed.

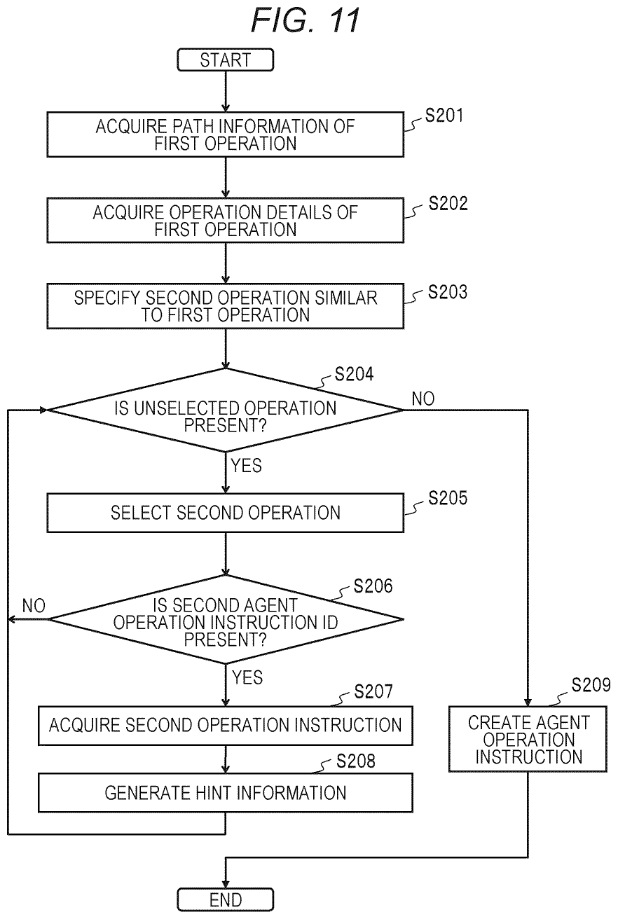

FIG. 11 is a flowchart for explaining an example of creation processing in step S200 in FIG. 10.

In the creation processing, first, the operation support program 200 acquires the path information of a first operation which is the response operation as the creation target of the agent operation instruction (step S201). For example, the operation support program 200 acquires the path information acquired in step S105 of FIG. 10 as the path information of the first operation.

The operation support program 200 acquires the operation details corresponding to the path information of the first operation as the operation details of the first operation from the procedure manual table 300 (step S202).

The operation support program 200 specifies a second operation that is the response operation having the operation details similar to the operation details of the first operation on the basis of the procedure manual table 300 (step S203).

Specifically, the operation support program 200 compares the search index of the first operation with the search index of the other operation, calculates a similarity between the search index of the other operation and the search index of the first operation for each of the other operations, and specifies the second operation on the basis of the similarity. For example, the operation support program 200 may specify a predetermined number of other operations as the second operations in descending order of similarity, or may specify other operations having similarity equal to or higher than a predetermined threshold as the second operations. For example, when the search index is a numerical vector, the similarity is a distance between the numerical vectors, and when the search index is a keyword, the similarity is a matching degree of the keyword. Furthermore, the similarity may be a value (for example, a weighted sum or the like) based on the distance between the numerical vectors and the matching degree of the keyword.

When the second operation is specified, the operation support program 200 determines whether there is an unselected second operation that has not yet been selected among the second operations (step S204).

When there is the unselected second operation (step S204: Yes), the operation support program 200 selects one of the unselected second operations as the selected operation (step S205). The operation support program 200 determines whether there is a second agent operation instruction ID, which is an agent operation instruction ID corresponding to the selected operation, in the operation instruction index table 400 (step S206).

When the second agent operation instruction ID does not exist (step S206: No), the operation support program 200 returns to the processing of step S204.

On the other hand, when the second agent operation instruction ID exists (step S206: Yes), the operation support program 200 acquires an agent operation instruction corresponding to the second agent operation instruction ID from the operation instruction table 600 as a selection operation instruction that is an agent operation instruction corresponding to the selected operation (step S207).

The operation support program 200 generates hint information in which the selected operation and the selection operation instruction are associated with each other (step S208), and returns to the processing of step S204.

In addition, in a case where there is no unselected second operation (step S204: No), the operation support program 200 creates an agent operation instruction corresponding to the first operation on the basis of the hint information (step S209), and ends the creation processing. For example, the operation support program 200 causes the LLM 151 to create an agent operation instruction corresponding to the first operation by inputting the hint information and a prompt to create an agent operation instruction on the basis of the hint information to the LLM 151.

When the creation processing ends, the operation support program 200 executes the process of step S108 in FIG. 10. At that time, the operation support program 200 acquires the agent operation instruction created in step S209 of FIG. 11 instead of acquiring the agent operation instruction corresponding to the correspondence ID or the match ID from the operation instruction table 600.

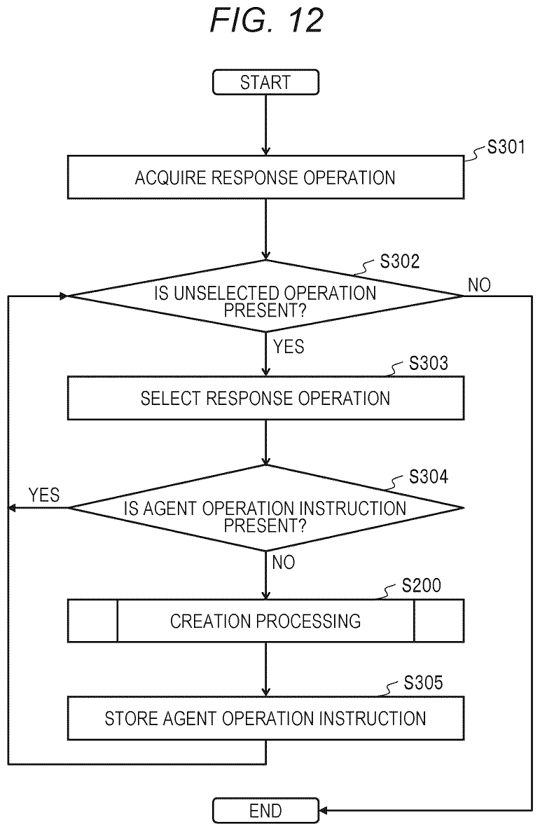

FIG. 12 is a flowchart for describing an example in which the creation processing is performed at another timing. In the examples of FIGS. 10 and 11, the agent operation instruction is created when the instruction sentence is input, but in the example of FIG. 12, a case where the agent operation instruction is created in advance for all the response operation will be described.

First, the operation support program 200 acquires all the response operations shown in the procedure manual table 300 at a predetermined timing (step S301). The predetermined timing is, for example, a timing at which creation of an agent operation instruction is instructed from the user.

The operation support program 200 determines whether there is an unselected response operation that has not yet been selected among the response operations (step S302).

When there is an unselected response operation (step S302: Yes), the operation support program 200 selects one of the unselected operations as the selected operation (step S303). The operation support program 200 determines whether or not there is a corresponding operation instruction which is an agent operation instruction corresponding to the selected operation in the operation instruction index table 400 (step S304).

When the corresponding operation instruction exists (step S304: No), the operation support program 200 returns to the processing of step S302.

On the other hand, when there is no corresponding operation instruction (step S304: Yes), the operation support program 200 executes creation processing of creating an agent operation instruction according to the selected operation (step S200).

When the agent operation instruction is created in the creation processing, the operation support program 200 adds the selected operation and the created agent operation instruction to the operation instruction table 600 in association with each other, and adds the path information of the selected operation and the agent operation instruction ID of the created agent operation instruction to the operation instruction index table 400 in association with each other (step S305), and returns to the processing of step S302.

As described above, according to the present embodiment, the storage unit 104 stores the procedure manual table 300 in which the procedure of the response operation according to the event is described for each operation, and the operation instruction table 600 in which the agent operation instruction which is the support information for supporting the operation of the agent 210 is indicated for each response operation. When the operation procedure in the procedure manual table 300 is referred to in the task based on the instruction sentence, the CPU 101 provides the agent 210 with an agent operation instruction corresponding to the target operation that is the response operation performed according to the operation procedure, and causes the agent 210 to execute the task on the basis of the agent operation instruction. Therefore, since it is possible to cause the agent 210 to appropriately execute processing according to the procedure of the response operation, it is possible to appropriately execute the operation according to the event.

In the present embodiment, when an operation procedure in the procedure manual table 300 is referred to in the middle of a task, the CPU 101 provides an agent operation instruction to the agent 210. Therefore, it is possible to execute processing according to the procedure of the response operation in response to the agent operation instruction as necessary.

Furthermore, in the present embodiment, the agent operation instruction indicates the execution order of the plurality of agents 210. In this case, the plurality of agents 210 can be executed in an appropriate order.

Furthermore, in the present embodiment, the agent operation instruction indicates the tool 211 used by the agent 210 in the task. The agent 210 can be caused to execute an appropriate tool.

In addition, in the present embodiment, regarding the first operation that is the response operation for which the agent operation instruction does not exist, the CPU 101 specifies the second operation that is the response operation similar to the first operation on the basis of the procedure manual table 300, and generates the support information corresponding to the first operation on the basis of the agent operation instruction corresponding to the second operation. In this case, it is possible to cause the agent 210 to appropriately execute a task even for a response operation for which an agent operation instruction is not prepared in advance.

Furthermore, in the present embodiment, the CPU 101 searches for a response operation for which no hand agent operation instruction exists at a predetermined timing, and generates an agent operation instruction corresponding to the response operation. Therefore, since it is possible to generate an agent operation instruction before actually executing a task or the like, it is possible to reduce a processing load or the like during the task.

The above-described embodiments of the present disclosure are examples for describing the present disclosure, and are not intended to limit the scope of the present disclosure only to those embodiments. Those skilled in the art can practice the present disclosure in various other aspects without departing from the scope of the present disclosure.

What is claimed is:

1. An operation support device that supports an operation corresponding to an event by using an AI agent that executes a task based on an instruction sentence related to the operation, the operation support device comprising:
a storage unit that stores procedure manual information describing a procedure of the operation for each of the operations and auxiliary information indicating support information for supporting an operation of the AI agent for each of the operations; and
a control unit that, in a case where the procedure in the procedure manual information is referred to in the task, provides support information corresponding to a target operation that is the operation performed according to the procedure to the AI agent, and causes the AI agent to execute the task on the basis of the support information.

2. The operation support device according to claim 1, wherein in a case where the procedure in the procedure manual information is referred to in the middle of the task, the control unit provides the support information to the AI agent, and causes the AI agent to continue the task on the basis of the support information.

3. The operation support device according to claim 1, wherein
the AI agent includes a plurality of AI agents, and
the support information indicates an execution order of the plurality of AI agents.

4. The operation support device according to claim 1, wherein
the AI agent includes one or more tools that perform specific processing, and
the support information indicates the tool used by the AI agent in the task.

5. The operation support device according to claim 1, wherein the control unit specifies, for a first operation that is an operation for which the support information does not exist in the auxiliary information, a second operation that is an operation similar to the first operation on the basis of the procedure manual information, and generates support information corresponding to the first operation on the basis of support information corresponding to the second operation.

6. The operation support device according to claim 5, wherein when support information corresponding to the target operation does not exist, the control unit generates the support information with the target operation as the first operation.

7. The operation support device according to claim 5, wherein the control unit searches for the first operation from the procedure manual information at a predetermined timing and generates support information corresponding to the first operation.

8. The operation support device according to claim 5, wherein the control unit generates the support information using a generative AI model.
